(19) United States
(12) Patent Application Publication
(10) Pub. No.: US 2024/0425200 A1
(43) Pub. Date: Dec. 26, 2024

(54) Aerodrome Structure and Construction Thereof

(71) Applicant: Urban Air Port Limited, London (GB)

(72) Inventors: Andrea Fang-Ning WU-SANDHU, London (GB); Alan JONES, London (GB); Harpreet Singh SANDHU, London (GB)

(21) Appl. No.: 18/570,228

(22) PCT Filed: Jun. 15, 2022
(86) PCT No.: PCT/EP2022/066310

§ 371 Date: Dec. 15, 2023

(30) Foreign Application Priority Data
Jun. 15, 2021 (GB) 2108526.1
Apr. 14, 2022 (GB) 2205587.5

(51) Int. Cl. B64F 1/222; E04B 1/342; E04B 1/343

(52) U.S. Cl. CPC B64F 1/222; E04B 1/342; E04B 1/34384

(57) ABSTRACT

A lift structure for an aerodrome structure comprises: an upstanding tubular frame comprising an upper ring located over a base ring and supported thereon by columns: a platform located within the tubular frame; and a lift mechanism arranged to raise and lower the platform between the base ring and the upper ring. The columns are spaced apart from each other to provide a side opening for loading an aircraft onto the platform and unloading an aircraft therefrom when the platform is in a lowered position. The platform provides a take-off and landing pad for an aircraft when the platform is in a raised position. An aerodrome structure comprises the lift structure and additional elements.

### BACKGROUND

The present disclosure relates to an aerodrome structure and a lift structure for an aerodrome structure, and the construction thereof.

Current transportation systems are increasingly clogged and polluting, with city centres and urban areas frequently overcrowded with conventionally-powered public transport, delivery lorries (trucks), and privately owned vehicles. These conditions are detrimental to the economy and the environment, in particular with regard to particulate pollution and climate change.

These problems may be alleviated to some extent by the use of small, short-range, vertical take-off and landing aircraft, which may be manned or unmanned (“drones”), and which may be used for transportation of people and goods. Such aircraft may be electrically-powered, or comprise hybrid power systems which combine different energy sources, and are therefore more “eco-friendly” than conventional fossil-fuelled aircraft. These kinds of aircraft may also find utility in settings other than towns and cities, for example in humanitarian aid in Disaster Emergency Management, and in military applications.

The flights of these aircraft will need to be effectively and safely managed in controlled airspace by the aviation authorities. Furthermore, the aircraft will require ground infrastructure, for take-off and landing, passenger and cargo handling, charging/refuelling, and so on. The present disclosure aims to address this infrastructure need, in an efficient, flexible, robust, and cost-effective manner.

Also, there is increasing emphasis in the infrastructure sector on sustainability and low environmental impact.

In this context, it may be preferable to work with the landscape rather than to change it.

### SUMMARY

According to an aspect of the disclosure, there is provided a lift structure for an aerodrome structure, comprising: an upstanding tubular frame comprising an upper ring located over a base ring and supported thereon by columns; a platform located within the tubular frame; and a lift mechanism arranged to raise and lower the platform between the base ring and the upper ring, wherein: the columns are spaced apart from each other to provide a side opening for loading an aircraft onto the platform and unloading an aircraft therefrom when the platform is in a lowered position; and the platform provides a take-off and landing pad for an aircraft when the platform is in a raised position.

As used herein, “aerodrome structure” (or in US English: “airdrome”) means a structure or installation from which flight operations take place, including the departure (i.e. take-off) and arrival (i.e. landing) of aircraft and the loading and unloading of passengers and/or cargo. The structure may (or may not) additionally be arranged to accommodate aircraft storage, aircraft maintenance facilities, aircraft refuelling/recharging facilities, passenger accommodation such as a passenger lounge, and air traffic control facilities.

The lift structure forms a core assembly of the aerodrome structure. During in-service operation, the platform of the lift structure enables the loading, unloading, take-off, and landing, of aircraft. As will be explained later herein, the lift structure and its platform also perform a key role in the construction of the aerodrome structure itself, prior to entry into operational service.

The lift structure may comprise base support cross-members located within the base ring and connected thereto, the lift mechanism being located beneath the platform and supported by the base support cross-members.

The platform may comprise discrete first and second platform parts; and the lift mechanism may be arranged to raise and lower the first and second platform parts independently of each other in one mode of operation.

The lift mechanism may be arranged to raise and lower the first and second platform parts together in another mode of operation.

The lift mechanism may comprise at least one chain link lift located beneath the platform.

The lift structure may comprise guide rails extending between the base ring and the upper ring, the platform being movably connected to the guide rails, the lift mechanism being arranged to raise and lower the platform along the guide rails between the base ring and the upper ring.

According to another aspect of the disclosure, there is provided an aerodrome structure, comprising: a lift structure as described herein above; a plurality of anchor members located on the ground around the lift structure; a plurality of radially-extending stabilisation members each comprising a first end connected to the upper ring and a second end connected to a respective one of the anchor members; and a plurality of cladding segments supported by the stabilisation members, each cladding segment spanning a gap between an adjacent pair of the stabilisation members and extending between the upper ring and the second ends of said adjacent pair of the stabilisation members, thereby to define a covered interior volume of the aerodrome structure.

The interior volume (i.e. internal space) may be segmented or partitioned to host multiple capabilities that contribute to the overall role of the aerodrome structure.

Each of the cladding segments may comprise a fabric material.

The fabric material may comprise PVC-coated polyester.

One or more of: the base ring; the platform; the guide rails; the upper ring; the columns; and the stabilisation members, may comprise aluminium alloy or steel.

The aerodrome structure may comprise a hanger structure for accommodating at least one aircraft and located adjacent to the side opening, for loading an aircraft onto the platform and unloading an aircraft from the platform when the platform is in the lowered position.

The hanger structure may comprise hanger structure roof members connected to the upper ring and upstanding hanger structure columns connected to the hanger structure roof members and to respective ones of the anchor members.

The anchor members may be configured to be height adjustable in order to position the second ends of the stabilisation members at the same height as each other from a ground datum.

According to another aspect of the disclosure, there is provided a method of constructing the aerodrome structure described herein above, the method comprising: providing the base ring on the ground; providing the lift mechanism within the base ring; attaching the platform to the lift mechanism such that the platform is located above the lift mechanism; providing the upper ring on the platform; pivotably connecting first ends of the columns to the upper ring such that the columns are in spaced relationship with each other around the upper ring and extend radially from the upper ring toward the ground; pivotably connecting the first ends of the stabilisation members to the upper ring such that the stabilisation members are in spaced relationship with each other around the upper ring and extend radially from the upper ring toward the ground; activating the lift mechanism in order to raise the platform and thus the upper ring located thereon, thereby to draw the pivotably connected columns into a substantially vertical condition and the pivotably connected stabilisation members into an inclined condition with respect to the ground; locking the first ends of the columns and the first ends of the stabilisation members into fixed relationship with the upper ring; connecting second ends of the columns to the base ring so as to be in fixed relationship therewith; providing the anchor members on the ground and connecting the second ends of the stabilisation members to the respective anchor members so as to be in fixed relationship therewith; and attaching the cladding segments to the stabilisation members.

Due especially to the provision and configuration of the height-adjustable platform, the lift structure is an essentially self-erecting structure, which additionally enables the erection of other parts of the aerodrome structure. That is, the need for cranes or other heavy lifting equipment is eliminated. Thus, the platform has a dual function: firstly, it enables the construction of the aerodrome structure; and secondly, it serves as an in-service aircraft handling platform for loading, unloading, take-off, and landing. This dual-function aspect makes the aerodrome structure highly efficient in terms of its construction and operation.

The method of constructing the aerodrome structure may comprise adjusting the height of one or more of the anchor members in order to position the second ends of the stabilisation members at the same height as each other from a ground datum.

The method of constructing the aerodrome structure may comprise: before activating the lift mechanism in order to raise the platform, connecting first ends of guide rails to the base ring such that the guide rails extend upwardly from the base ring and are in spaced relationship with each other around the base ring and the platform; and connecting the guide rails to the platform such as to allow height adjustment of the platform relative to the guide rails.

The method of constructing the aerodrome structure may comprise: after activating the lift mechanism in order to raise the platform, connecting second ends of the guide rails to the upper ring so as to be in fixed relationship therewith.

The method of constructing the aerodrome structure may comprise assembling one or more of: the base ring; the platform; the guide rails; the upper ring; the columns; and the stabilisation members, from a plurality of discrete component parts.

According to another aspect of the disclosure, there is provided a kit of parts for the lift structure described herein above, comprising: a set of ring segments configured to be connected together to form the base ring; a set of ring segments configured to be connected together to form the upper ring; a plurality of sets of column segments, the segments of each set of column segments being configured to be connected together to form one of the columns, one of the segments in each set of column segments being configured to be connected to the base ring and another of the segments in each set of column segments being configured to be connected to the upper ring; a set of platform segments configured to be connected together to form the platform; and a lift mechanism configured to be connected to the platform.

The kit of parts may comprise a plurality of sets of guide rail segments, the segments of each set of guide rail segments being configured to be connected together to form one of the guide rails, one of the segments in each set of guide rail segments being configured to be connected to the base ring, each of the guide rails being configured to be connected to the platform.

According to another aspect of the disclosure, there is provided a kit of parts for the aerodrome structure described herein above, comprising: the kit of parts for the lift structure described herein above; a plurality of the anchor members; a plurality of sets of stabilisation member segments, the segments of each set of stabilisation member segments being configured to be connected together to form one of the stabilisation members, at least one of the segments in each set of stabilisation member segments being configured to be connected to the upper ring and another of the segments in each set of stabilisation member segments being configured to be connected to a respective one of the anchor members; and a plurality of the cladding segments.

Thus the inventive aerodrome structure uses a design philosophy encompassing a lightweight, rapidly deployable structure that comes as a contained (e.g. flat-packed) kit of parts, which can be constructed and deconstructed with minimal personnel and equipment. The parts are pre-designed/pre-engineered/pre-fabricated for inclusion in the structure, which is modular and scalable.

In its stored (flat-packed) state the aerodrome structure has the ability to be transported (via land, sea or air) in a set of conventional haulage containers. This provides for a geographically-reusable “pop-up” infrastructure that can be positioned in either a rural, urban or city location, either at ground level or on top of a building. As a scalable, adaptable structural framework and foot print, it has a transformation capability that matches the needs of its role and the environment in which it is situated.

As drop-off and pick-up points, the operational flexibility of the aerodrome structure can ensure that Urban Air Mobility (UAM) air corridors are supplemented with safe and effective landing zones that will meet future urban aviation demands dictated by society and industry; whether there is a need to re-deploy due to population catchment changes, expanding urban environments, industrial relocations, or humanitarian aid.

In a further aspect of the disclosure, there is provided a foot for supporting a piece of infrastructure, the foot comprising:
a platform having a first portion, a second portion and a central portion between the first portion and the second portion;
a first base, configured to support the first portion of the platform via at least a first four rods that each extend between the first base and the first portion to an independently separately adjustable extent;
a second base, configured to support the second portion of the platform via at least a second four rods that each extend between the second base and the second portion to an independently adjustable extent;
a first pair of legs projecting upwards from the first portion of the platform;
a second pair of legs projecting upwards from the second portion of the platform;
a beam having a first end and a second end, wherein the first end is supported by the first pair of legs and the second end is supported by the second pair of legs;
wherein:
adjustment of the extent to which the first four rods extend between the first base and the first portion and adjustment of the extent to which the second four rods extend between the second base and the second portion enables adjustment of the platform so as to be horizontal when the first base is non-horizontal and when the second base is both non-horizontal and non-parallel with the first base;
the first pair of legs comprises a first range of attachment positions for supporting the beam at a first variety of vertical positions and the second pair of legs comprises a second range of attachment positions for supporting the beam at a second variety of vertical positions that correspond with the first variety of vertical positions, such that a height of the beam is selectable by selecting one of the first variety of vertical positions and a corresponding one of the second variety of vertical positions and such that the beam is parallel to the platform.

This allows for rapid deployment of the foot for rapid construction of infrastructure in a range of settings without the requirement to alter the landscape, or to undertake piling operations or to pour concrete.

In this way, the foot may be particularly appropriate for non-permanent structures or structures deployed rapidly, such as in disaster areas.

The foot may alternatively be termed a terrain adjustable foundation.

One particular application of the foot may be for use in supporting a structure configured for use as an airport for vertical take off and landing aircraft.

The first pair of legs may comprise a first leg and a second leg, wherein the first leg and the second leg are mutually parallel. The second pair of legs may comprise a third leg and a fourth leg, wherein the third leg and the fourth leg are mutually parallel.

The first pair of legs may be parallel to the second pair of legs.

The first pair of legs may project upwards from the first portion of the platform entirely within a first area defined by a first boundary that links the first four rods; and the second pair of legs may project upwards from the second portion of the platform entirely within a second area defined by a second boundary that links the second four rods.

The first four rods may be symmetrically disposed relative to the first base and the second four rods may be symmetrically disposed relative to the second base.

The first pair of legs may be symmetrically disposed relative to the first base and the second pair of legs may be symmetrically disposed relative to the second base.

In this way, stability of the foot may be increased.

A lower surface of the first base and a lower surface of the second base each comprise a material having a coefficient of friction that exceeds a friction threshold.

In this way, a risk of lateral slippage of the foot is reduced.

In a further aspect of the disclosure there is provided an assembly comprising a pair of feet, wherein each foot is in accordance with a foot of the disclosure. The assembly further comprises:
a connecting shaft extending between the beam of the first foot and the beam of the second foot:
wherein by adjustment of the first four rods and the second four rods of the first foot, and by adjustment of the first four rods and the second four rods of the second foot, the platforms of the first and second feet are mutually parallel, and
wherein by appropriate selection of the first and second range of attachment positions for the first foot and by appropriate selection of the first and second range of attachment positions for the second foot, the beam is supported horizontally.

In this way, an assembly may maintain horizontality when each of the two feet is placed on separately inclined surfaces.

Fine adjustment to achieve horizontality of the beam may be achievable by further adjustment of the extent to which the first four rods extend between the first base and the first portion and by further adjustment of the extent to which the second four rods extend between the second base and the second portion.

In this way, the expectation of horizontality not just for a single foot, but across the assembly having more than one foot, may be increased.

In a further aspect of the disclosure there is provided a structure comprising a plurality of pairs of feet as already described, and a plurality of connecting shafts, wherein each pair of feet of the plurality of pairs of feet is connected to each adjacent pair of feet by a connecting shaft of the plurality of connecting shafts.

In this way, a building having a horizontal floor may be rapidly constructed on uneven ground.

In a further aspect of the disclosure there is provided a structure having a polygon plan view shape having N sides, comprising N feet in accordance with the disclosure and N connecting shafts.

All of the N connecting shafts may sit in a first horizontal plane.

A floor of the structure may be supported in the first horizontal plane.

The structure may further comprise a plurality of roof members, wherein the beam of each of the plurality of feet supports a roof member and the plurality of roof members extend radially towards a central area of the structure.

A central area of the structure may comprise a ring portion within which is located a platform for vertical take off and landing aircraft.

Any apparatus, system, or structural feature described herein may be provided as a method feature, and vice versa. Moreover, it will be understood that the present disclosure is described herein purely by way of example, and modifications of detail can be made within the scope of the claims. Furthermore, it will be understood by the skilled person that particular combinations of the various features described and defined herein may be implemented and/or supplied and/or used independently. In particular, it will be understood by the skilled person that any feature described in relation to a particular aspect herein may also be applied to another aspect described herein, in any appropriate combination.

### FURTHER ASPECTS OF THE DISCLOSURE

Further aspects of the disclosure are set out in the following numbered clauses:

1. A foot (100) for supporting a piece of infrastructure (10), the foot (100) comprising:
a platform (200) having a first portion (210), a second portion (220) and a central portion (230) between the first portion (210) and the second portion (220);
a first base (300), configured to support the first portion (210) of the platform (200) via at least a first four rods (310, 320, 330, 340) that each extend between the first base (300) and the first portion (210) to an independently separately adjustable extent;
a second base (400), configured to support the second portion (220) of the platform (200) via at least a second four rods (410, 420, 430, 440) that each extend between the second base (400) and the second portion (220) to an independently adjustable extent;
a first pair of legs (510, 520) projecting upwards from the first portion (210) of the platform (200);
a second pair of legs (530, 540) projecting upwards from the second portion (220) of the platform (200);
a beam (600) having a first end and a second end, wherein the first end is supported by the first pair of legs (510, 520) and the second end is supported by the second pair of legs (530, 540);
wherein:
adjustment of the extent to which the first four rods (310, 320, 330, 340) extend between the first base (300) and the first portion (210) and adjustment of the extent to which the second four rods (410, 420, 430, 440) extend between the second base (400) and the second portion (220) enables adjustment of the platform (200) so as to be horizontal when the first base (300) is non-horizontal and when the second base (400) is both non-horizontal and non-parallel with the first base (300);
the first pair of legs (510,520) comprises a first range of attachment positions (550) for supporting the beam (600) at a first variety of vertical positions and the second pair of legs (530, 540) comprises a second range of attachment positions (550) for supporting the beam (600) at a second variety of vertical positions that correspond with the first variety of vertical positions, such that a height of the beam (600) is selectable by selecting one of the first variety of vertical positions and a corresponding one of the second variety of vertical positions and such that the beam (600) is parallel to the platform (200).
   2. The foot of clause 1 wherein:
the first pair of legs comprises a first leg and a second leg, wherein the first leg and the second leg are mutually parallel;
the second pair of legs comprises a third leg and a fourth leg, wherein the third leg and the fourth leg are mutually parallel.
   3. The foot of clause 1 or clause 2 wherein:
the first pair of legs is parallel to the second pair of legs.
   4. The foot of any preceding clause wherein:
the first pair of legs projects upwards from the first portion of the platform entirely within a first area defined by a first boundary that links the first four rods; and
the second pair of legs projects upwards from the second portion of the platform entirely within a second area defined by a second boundary that links the second four rods.
   5. The foot of any preceding clause wherein the first four rods are symmetrically disposed relative to the first base and the second four rods are symmetrically disposed relative to the second base.
   6. The foot of any preceding clause wherein the first pair of legs is symmetrically disposed relative to the first base and the second pair of legs is symmetrically disposed relative to the second base.
   7. The foot of any preceding clause wherein a lower surface of the first base (300) and a lower surface of the second base (400) each comprise a material having a coefficient of friction that exceeds a friction threshold.
   8. An assembly comprising a pair of feet, wherein each foot of the pair of feet is an accordance with any preceding clause, the assembly further comprising:

a connecting shaft extending between the beam of the first foot and the beam of the second foot:

wherein by adjustment of the first four rods and the second four rods of the first foot, and by adjustment of the first four rods and the second four rods of the second foot, the platforms of the first and second feet are mutually parallel, and
wherein by appropriate selection of the first and second range of attachment positions for the first foot and by appropriate selection of the first and second range of attachment positions for the second foot, the beam is supported horizontally.
   9. The assembly of clause 8 wherein fine adjustment to achieve horizontality of the beam is achievable by further adjustment of the extent to which the first four rods extend between the first base and the first portion and by further adjustment of the extent to which the second four rods extend between the second base and the second portion.
   10. A structure comprising a plurality of pairs of feet in accordance with the foot of any of clauses 1 to 7, and a plurality of connecting shafts, wherein each pair of feet of the plurality of pairs of feet is connected to each adjacent pair of feet by a connecting shaft of the plurality of connecting shafts.
   11. A structure having a polygon plan view shape having N sides, comprising N feet in accordance with any of clauses 1 to 7 and N connecting shafts.
   12. The structure of clause 11 wherein all of the N connecting shafts sit in a first horizontal plane.
   13. The structure of clause 12 wherein a floor of the structure is supported in the first horizontal plane.
   14. The structure of any one of clauses 11 to 13 further comprising a plurality of roof members, wherein the beam of each of the plurality of feet supports a roof member and the plurality of roof members extend radially towards a central area of the structure.
   15. The structure of clause 14 wherein a central area of the structure comprises a ring portion within which is located a platform for vertical take off and landing aircraft.

### BRIEF DESCRIPTION OF THE DRAWINGS

FIGS. 1 and 2 show an aerodrome structure according to the disclosure;

FIGS. 3a-c and 4 show portions of some component parts of the aerodrome structure;

FIGS. 5 to 7 show a construction sequence of the aerodrome structure;

FIGS. 8 and 9 relate to cladding which is disposed on the aerodrome structure;

FIGS. 10 and 11 show window features of the aerodrome structure;

FIGS. 12 and 13 relate to a lift apparatus of the aerodrome structure;

FIG. 14 shows ground support features of the aerodrome structure;

FIG. 15 shows another configuration of window features of the aerodrome structure.

FIG. 16 shows a first embodiment of a foot in accordance with the present disclosure;

FIG. 17 shows the foot of FIG. 16 with ballast portions;

FIG. 18 shows the foot of FIG. 16 from a different perspective;

FIG. 19 shows a cross sectional view of the foot of FIG. 16 when place on uneven ground;

FIG. 20 shows a cross sectional view of the foot of FIG. 16 when placed on uneven ground with the ground at a lower level than as shown in FIG. 19;

FIG. 21 shows a side view of a building, specifically an air port for vertical take off and landing vehicles, that makes use of the feet of FIG. 16;

FIG. 22 shows a plan view of the building of FIG. 21.

### DETAILED DESCRIPTION

### Aerodrome Structure

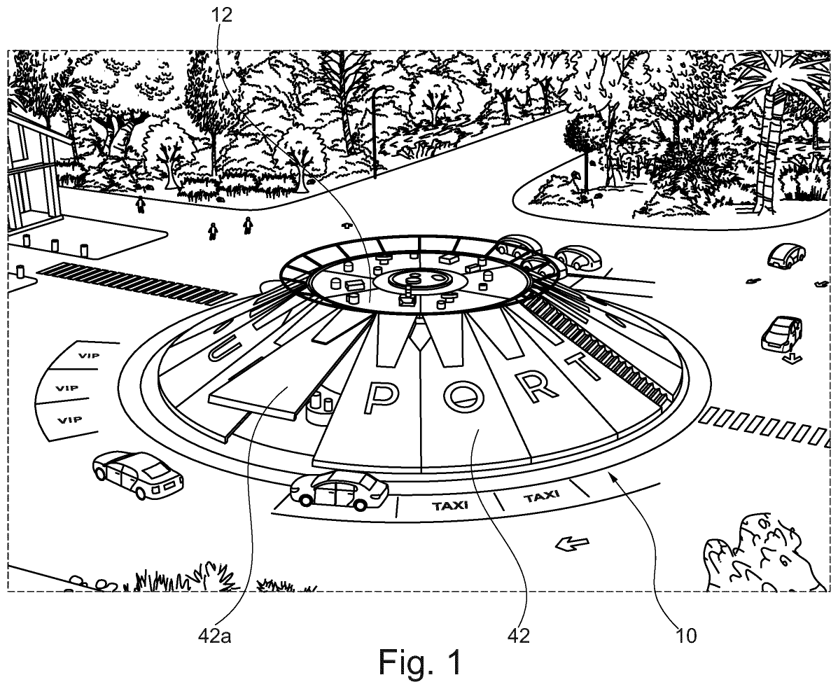

Referring to FIG. 1, an aerodrome structure 10 or installation according to the disclosure has the form of a shallow, truncated cone. The aerodrome structure 10 includes a platform 12 arranged to be raised and lowered, between the ground within the interior of the aerodrome structure 10 and an upper region or top of the aerodrome structure 10 (per the position of the platform 12 shown in FIG. 1). With regard to departing aircraft, the platform 12 functions to move the aircraft from ground level to the top of the aerodrome structure 10 and provides a take-off pad for the aircraft. With regard to arriving aircraft, the platform 12 provides a landing pad and serves to move the aircraft from the top of the aerodrome structure 10 to ground level.

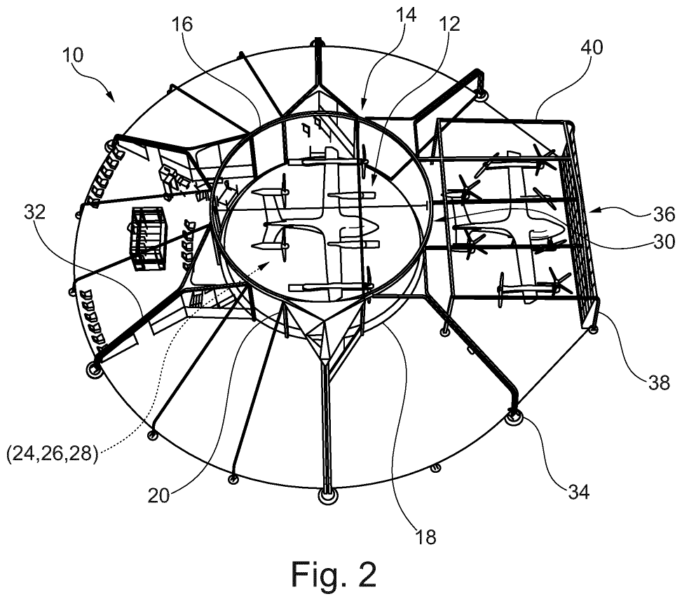

As can be seen in FIG. 2, the platform 12 is one element of a lift structure 14 which forms a central, core assembly of the aerodrome structure 10. As will be explained herein, the lift structure 14 and its platform 12 enables the construction of the aerodrome structure 10 itself, as well as handling the movements of aircraft when the aerodrome structure 10 is in-service.

The lift structure 14 comprises an upstanding tubular frame including an upper ring 16 located directly above a lower or base ring 18 which lies on the ground. The upper ring 16 is supported over the base ring 18 by a plurality of substantially vertical lift structure columns 20 which are spaced apart from each other around the circumference of the upper and base rings 16, 18. In this example, the lift structure comprises eight lift structure columns 20. In this example, the lift structure columns 20 comprise steel. In this example, the upper and base rings 16, 18 comprise steel.

The platform 12 is disc-shaped and is located within the tubular frame and extends laterally or horizontally, i.e. in a direction which is substantially perpendicular with the longitudinal or vertical axis of the tubular frame. The platform 12 has a diameter or span which is slightly smaller than that of the base ring 18 and the upper ring 16. In this example, the platform 12 comprises aluminium alloy. The platform 12 is movably connected to guide rails 22 (not shown in FIG. 2) which extend between the base ring 18 and the upper ring 16 and which are spaced apart around the circumference thereof. In this example, the lift structure 14 comprises four guide rails 22. In this example, the guide rails 22 comprise steel.

Lift apparatus 24 (not visible in FIG. 2) is provided beneath the platform 12 (i.e. between the platform 12 and the underlying ground) and is arranged to raise and lower the platform 12 between the base ring 18 and the upper ring 16. In this example, the lift apparatus 24 is supported on rest plates 26 (not visible in FIG. 2) which are arranged within the circumference of the base ring 18. Further in this example, the rest plates 26 are themselves supported on or between ground-based base cross-beams 28 (not visible in FIG. 2) which extend across the diameter of the base ring 18 and are connected thereto. In this example, the base cross-beams 28 comprise steel.

The spacing of the lift structure columns 20 and the guide rails 22 is configured such as to provide a side opening 30 of the lift structure 14, for loading an aircraft onto the platform 12 and unloading an aircraft from the platform 12 when the platform 12 is in a lowered position, i.e. such as to be located in the region of the base ring 18. When the platform 12 is in a raised position, i.e. such so as to be located in the region of the upper ring 16, the platform 12 provides a take-off and landing pad for an aircraft. Thus the platform 12 may also be referred to as a Final Approach and Take-Off or “FATO” platform. As such, the platform 12 is configured to meet relevant aviation regulations. In this regard, the platform 12 comprises appropriate markings, navigation lighting and equipment, and a surface material which is non-slip, durable, and corrosion resistant.

Still referring to FIG. 2, the aerodrome structure 10 further comprises Y-shaped outriggers or stabilisation beams 32, which provide enhanced lateral stabilisation to the lift structure 14 and also form an additional structure of the aerodrome structure 10. In this example, the aerodrome structure 10 comprises six of the beams 32. In this example, the beams 32 comprise steel. As can be seen in the drawing, the Y-shaped stabilisation beams 32 slope downwardly and outwardly away from the lift structure 14. The two inner ends of each Y-shaped stabilisation beam 32 are fixedly connected to the upper ring 16, in particular at the same portions of the upper ring 16 to which a respective two of the lift structure columns are fixedly connected. The outer end of each Y-shaped stabilisation beam 32 is fixedly connected to a respective anchor member 34 which is in contact with the ground. An outer portion of the beam 32 which includes said outer end is cranked downwardly, i.e. the beam 32 changes in plane in side profile, such as to be inclined from the ground at a greater angle than is the mid-portion of the beam 32.

The aerodrome structure 10 further comprises a hanger structure 36 for accommodating aircraft entering and leaving the platform 12. The hanger structure 36 comprises a plurality of upstanding hanger structure columns 38 which are fixedly connected to a plurality of hanger structure roof members 40, ends of some of the hanger structure roof members 40 being fixedly connected to the upper ring 16 of the lift structure 14. An outer region of the hanger structure (i.e. to the right-hand side in the sense of FIG. 2) includes an entrance/exit for aircraft to enter/leave the aerodrome structure 10.

Referring again to FIG. 1, the aerodrome structure 10 further comprises an outer covering or cladding which is attached to the Y-shaped stabilisation beams 32 and defines a covered inner volume of the aerodrome structure 10. The cladding comprises a plurality of cladding segments 42, each of the segments spanning a space between an adjacent pair of the Y-shaped stabilisation beams. In this example, the cladding segments 42 comprise a fabric material, more particularly a PVC-coated polyester.

In this example: the aerodrome structure 10 has a height at the upper ring 16 of about 7.3 m and the upper ring 16 has a diameter of about 17.4 m; the platform 12 has a diameter of about 17 m; each of the Y-shaped stabilisation beams 32 has a length of about 12 m.

The aerodrome structure 10 is most suitable for vertical take-off and landing (VTOL) aircraft. That is, aircraft that can hover, take off, and land vertically. This includes various kinds of aircraft, including rotary-wing aircraft, i.e. helicopters, and other aircraft with powered rotors, such as cyclogyros, cyclocopters and tiltrotors. Also included are VTOL aircraft that may operate in other modes, e.g. STOL (short take-off and landing), or STOVL (short take-off and vertical landing), and lighter-than-air aircraft. The aircraft may be manned or unmanned (“drones” or UAVs). The aircraft may carry passengers or cargo, or both. In some applications, the aircraft may carry humanitarian aid supplies, or military equipment such as weaponry. The aircraft may be powered by electricity, fossil-fuels, or a combination of these.

The aerodrome structure 10 or installation may comprise its own supply of electrical power, for example by means of wind, solar or hydro, or alternatively may rely on an external supply, for example from the mains grid where the aerodrome structure 10 is located. Whatever the supply source, the aerodrome structure 10 or installation may be arranged to store electrical power, for example using batteries. Excess stored electricity may be fed into the mains grid, if desired. The electrical energy may be used to recharge electrically-powered aircraft which use the aerodrome structure 10. Furthermore, the aerodrome structure 10 may include storage facilities for fossil fuels or hydrogen, in order to be able to refuel aircraft using those fuels.

### Assembly

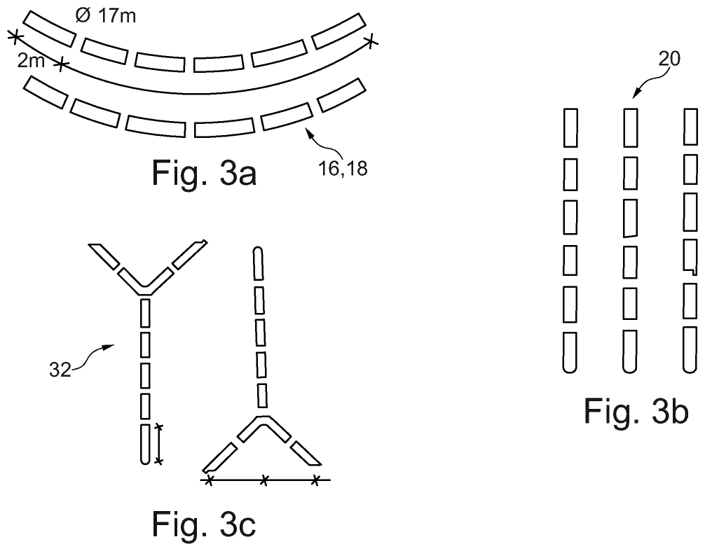

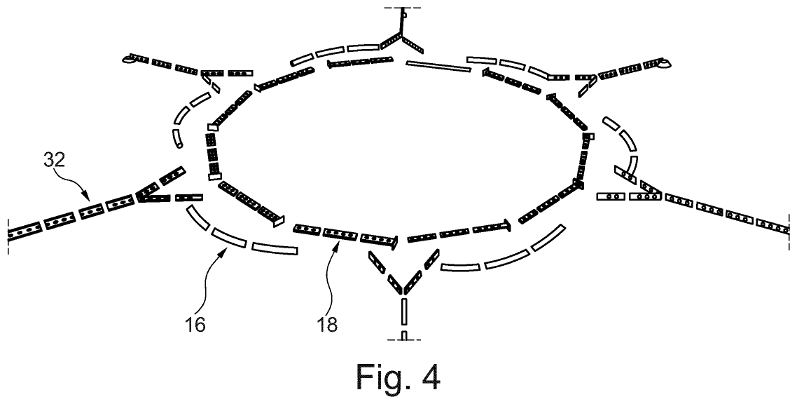

The aerodrome structure 10 is constructed from its component parts which are originally packaged in containers, for example standard-size shipping containers, for convenient deployment to the site where the aerodrome structure 10 is to be erected. Some examples of the component parts of the lift structure 14 are shown in FIGS. 3a-c, in particular the upper and base rings 16, 18 (see FIG. 3a), the lift structure columns 20 (see FIG. 3b), and the Y-shaped stabilisation beams 32 (see FIG. 3c). As can be seen in the drawings, in this example each of these component parts, as well as some or all of the other component parts of the aerodrome structure 10, comprises a plurality of discrete segments or elements which are configured to be connected or joined together in order to form the parts. In this example, the elements each have a length of about two metres.

The construction or assembly of the aerodrome structure 10 will now be described, with particular reference to FIGS. 4 to 6.

Referring to FIG. 4, the elements of the component parts of the aerodrome structure 10 are taken from their containers and arranged on the ground at the construction site. The elements of some of the component parts are then connected together in order to form the individual component parts (not all of which are shown in FIG. 4). Thus, in this example, the relevant elements are connected together to first form the base ring 16, the lift structure columns 20, the base cross-beams 28, the Y-shaped stabilisation beams 32, the hanger structure columns 38, and the hanger structure roof members 40. Furthermore, ends of the hanger structure columns 38 are hingedly or pivotably connected to respective ends of the hanger structure roof members 40 in order to pre-assemble the hanger structure 36.

The base cross-beams 28 are placed on the ground inside the circumference of the base ring 18 and their ends are attached to respective portions of the base ring 18. The rest plates 26 are mounted on or between the base cross-beams 28. The lift apparatus 24 is mounted on the rest plates 26.

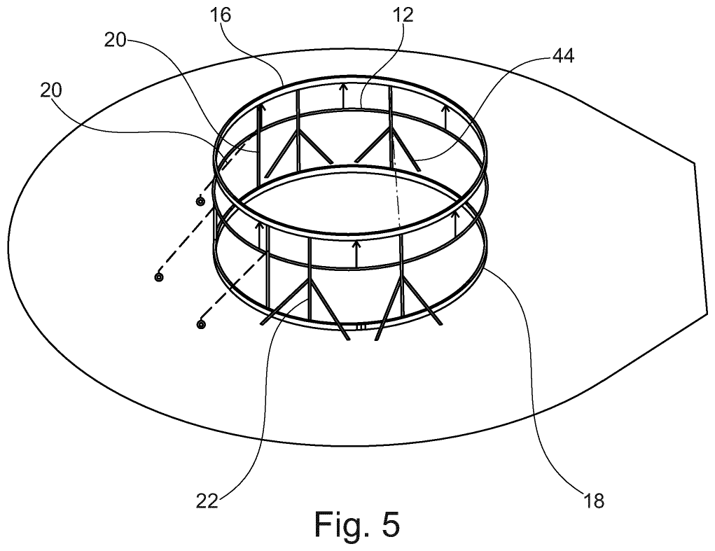

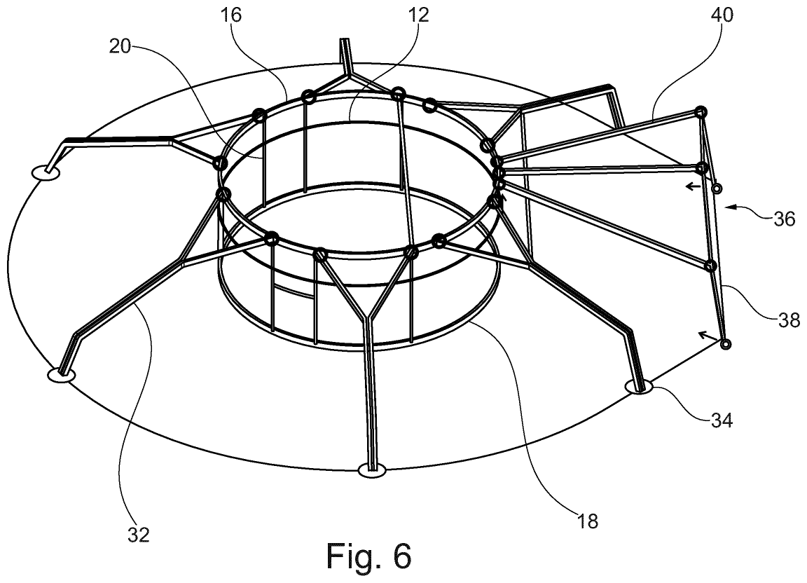

Referring to FIGS. 5 and 6, each segment of the platform 12 (only the outer circumference of which is shown in the drawings) is positioned over the lift apparatus 24 (not shown) and is attached thereto. The segments of the platform 12 are connected together, either before or after attachment to the lift apparatus 24. Thus, the platform 12 is positioned and supported slightly above the level of the base ring 18.

The elements of the guide rails 22 are assembled and the guide rails 22 are raised into an upright position and their lower ends are fixedly attached to the base ring 18. Alternatively, the elements of the guide rails 22 may be connected one on top of another such as to build the guide rails 22 up in the vertical direction from the base ring 18. Preferably, temporary stabilisation struts 44 are attached to the outer surfaces of the guide rails 22 in order to provide additional lateral stabilisation during assembly. Thus, the guide rails 22 extend vertically from the base ring 18 and surround or encircle the platform 12. Preferably, the outer edge of the platform 12 includes radially-extending projections which are received in channels provided in the inner surfaces of the guide rails 22, thereby to engage the platform 12 with the guide rails 22 and prevent rotational movement of the platform 12 with respect to the guide rails 22, which themselves provide improved lateral stability . . .

The segments of the upper ring 16 are positioned on the platform 12 and connected together to form the upper ring 16. Since the diameter of the upper ring 16 is slightly greater than the diameter of the platform 12, at least one temporary cross-member may be attached to the upper ring 16 such as to extend between opposing portions of the upper ring 16, in order to support the upper ring 16 on the platform 12. Alternatively, the same supporting effect may be achieved by attaching a temporary inner lip part to the upper ring 16, such that the underside of the inner lip rests on the radially-outer part of the platform 12.

With the upper ring 16 assembled and rested on the platform 12, the lift structure columns 20 are arranged in spaced-relationship with each other around the circumference of the upper ring 16 so as to project radially therefrom. The inner ends of the lift structure columns 20 are hingedly or pivotably connected to the upper ring 16, while the outer ends of the lift structure columns 20 are rested on the ground. Thus, the lift structure columns 20 slope downwardly from the upper ring 16 to the ground (as depicted by the dashed lines of the lift structure columns 20 in FIG. 5).

In a similar manner, the Y-shaped stabilisation beams 32 (not shown in FIG. 5) are arranged in spaced-relationship with each other around the circumference of the upper ring 16 so as to project radially therefrom. The inner ends of each Y-shaped stabilisation beam 32 are hingedly or pivotably connected to the upper ring 16, at the same portions of the upper ring 16 to which a respective two of the lift structure columns are hingedly or pivotably connected, while the outer end of each Y-shaped stabilisation beam 32 is rested on the ground. Thus, the Y-shaped stabilisation beams 32 slope downwardly from the upper ring 16 to the ground.

Free ends of the hanger structure roof members 40 of the pre-assembled hanger structure 36 (not shown in FIG. 5) are hingedly or pivotably connected to the upper ring 16. Furthermore, the hanger structure columns 38 (which it will be recalled are hingedly or pivotably connected to the other ends of the respective hanger structure roof members 40) are extended radially outward so as to lie in a generally straight line with the hanger structure roof members 40). Thus, the hanger structure roof members 40 and the hanger structure columns 38 slope downwardly from the upper ring 16 to the ground.

The lift apparatus 24 is activated in order to raise the platform 12, and thereby the upper ring 16 which rests on the platform 12, vertically upward. The upstanding guide rails 22 serve to guide the platform 12 in its upward motion. As the upper ring 16 ascends with the platform 12, the pivotably-connected lift structure columns 20 freely rotate in a plane which is perpendicular with the plane of the upper ring 16. Thus, the lift structure columns 20 are drawn upward and inward, their inclination relative to the ground progressively increasing until they reach a substantially vertical condition. Preferably, the outer ends of the lift structure columns 20 are equipped with castor wheels to facilitate their inward travel over the ground.

In a similar manner, the Y-shaped stabilisation beams 32 (which are of greater length than the lift structure columns 20) are also drawn upward and inward during the upward motion of the platform 12 and the upper ring 16, their inclination relative to the ground also progressively increasing until they reach an inclination angle of around 45 degrees, in this example. Preferably, the outer ends of the Y-shaped stabilisation beams 32 are equipped with castor wheels to facilitate their inward travel over the ground.

Also in a similar manner, the hanger structure roof members 40 and the hanger structure columns 38 are drawn upward and inward during the upward motion of the platform 12 and the upper ring 16, their inclination relative to the ground also progressively increasing. The inclination of the hanger structure columns 38 may be manually adjusted during (or after) the rise of the platform 12, in order to set the desired final inclination of the hanger structure roof members 40 relative to the ground. For example, the hanger structure columns 38 may be set at an inclination of about 90 degrees, i.e. substantially vertical, and the hanger structure roof members 40 at an inclination of zero degrees, i.e. substantially horizontal. Preferably, the outer ends of the hanger structure columns 38 are equipped with castor wheels to facilitate their inward travel over the ground.

The lift apparatus 24 is deactivated in order to halt the upward movement of the platform 12. Thus, the platform 12 is used to raise the upper ring 16, the hanger structure columns 38, the Y-shaped stabilisation beams 32, and the hanger structure 36, into position.

If fitted, the castor wheels are removed from the lift structure columns 20, the Y-shaped stabilisation beams 32 and the hanger structure columns 38. The lift structure columns 20, the Y-shaped stabilisation beams 32, and the hanger structure roof members 40, are locked in place, such as to transition from the pivotable relationship with the upper ring 16 to a fixed relationship therewith. Locking may be achieved manually, for example by a bolted connection, or automatically, for example by a spring-loaded locking mechanism provided at the interface with the upper ring 16. Self-locking mechanisms are commonly found in space-frame constructions, for example, with which the person skilled in the general art of construction will be familiar. Similarly, the hanger structure roof members 40 are locked in place relative to the hanger structure columns 38.

The lower ends (i.e. the aforementioned outer ends) of the lift structure columns 20 are fixedly connected to the base ring 18. In this way, the lift structure columns 20 provide a rigid connection between the upper and base rings 16, 18. In a similar manner, the upper ends of the guide rails 22 are rigidly connected to the upper ring 16 in order to provide additional structural rigidity to the upstanding tubular frame.

The outer ends of the Y-shaped stabilisation beams 32 are connected to their respective anchor members 34, which are provided on the ground, thereby enhancing lateral stability. The anchor members 34 may be placed on the ground in pre-determined positions prior to the upward and inward movement of the Y-shaped stabilisation beams 32, or alternatively put in place after said movement according to the final positions of the outer ends of the beams 32.

The temporary stabilisation struts 44 attached to the outer surfaces of the guide rails 22 are no longer required and are therefore removed. With the upper ring 16 thus fixed firmly in place, the temporary cross-member (or the temporary inner lip part) (not shown in the drawings) is also no longer needed and is therefore removed from the upper ring 16.

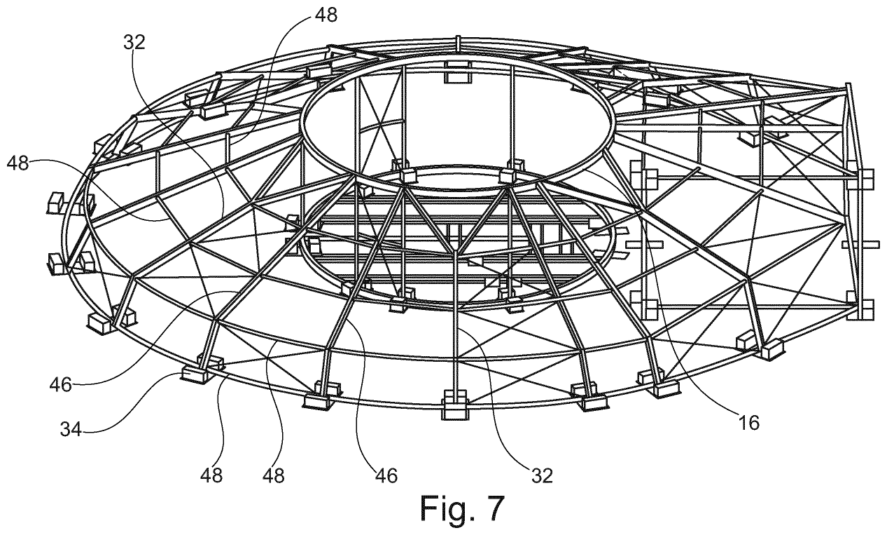

Referring to FIG. 7, in this example the aerodrome structure 10 comprises additional outriggers or stabilisation beams 46 which are disposed between the Y-shaped stabilisation beams 32. The additional stabilisation beams 46 comprise steel. An inner end of each additional stabilisation beam 46 is connected to the upper ring 16, while the outer end is connected to a respective additional supporting anchor member 34. Thus the additional stabilisation beams 46 slope downwardly and outwardly away from the lift structure 14, in a similar manner to the Y-shaped stabilisation beams 32. Furthermore, the side profile of the additional stabilisation beams 46 is similar to that of the Y-shaped stabilisation beams 32, including the downwardly-cranked outer portion. The additional stabilisation beams 46 are erected in the same manner as the Y-shaped stabilisation beams 32, i.e. the beams 46 are hingedly or pivotably attached to the upper ring 16, raised into the elevated position by the platform 12, and locked in place relative to the upper ring 16 once in the elevated position.

Also as shown in FIG. 7, in this example the aerodrome structure 10 comprises horizontally-arranged bracing members 48 which connect adjacent pairs of the Y-shaped stabilisation beams 32 and the additional stabilisation beams 46. The bracing members 48 may comprise steel. The bracing members 48 are connected to the beams 32, 46 after the beams 32, 46 have been placed into position as described herein above. In this example, the bracing members 48 form three rings which each extend circumferentially around the aerodrome structure 10, the rings being located at an upper region, a lower region, and a mid-region of the aerodrome structure 10. It will be understood that the bracing members 48 provide the aerodrome structure 10 with additional structural rigidity.

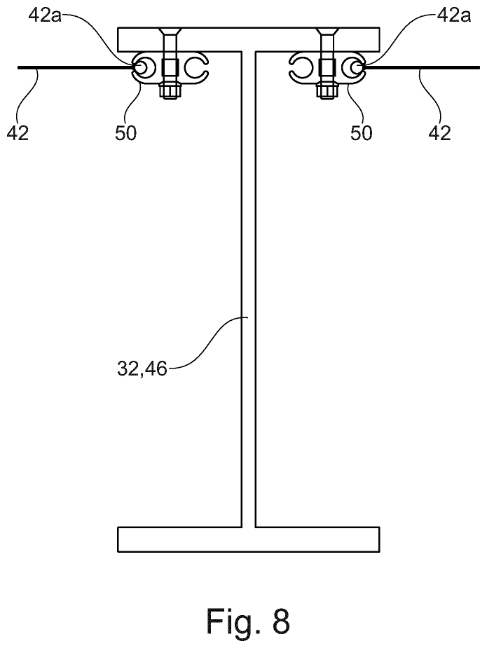

Referring next to FIG. 8, the Y-shaped stabilisation beams 32 and the additional stabilisation beams 46 provide a means of support for the cladding segments 42 which generally cover the aerodrome structure 10. More particularly, each of the Y-shaped stabilisation beams 32 and the additional stabilisation beams 46 is I-shaped in cross-section and twin luff tracks 50 or elongate channels are provided on the top of the flange parts of the beam 46. Each of the luff tracks 50 is configured to receive an edge of one of the cladding sections 42, the edge including a thickened keeper portion 42a for retaining the edge in the luff track 50.

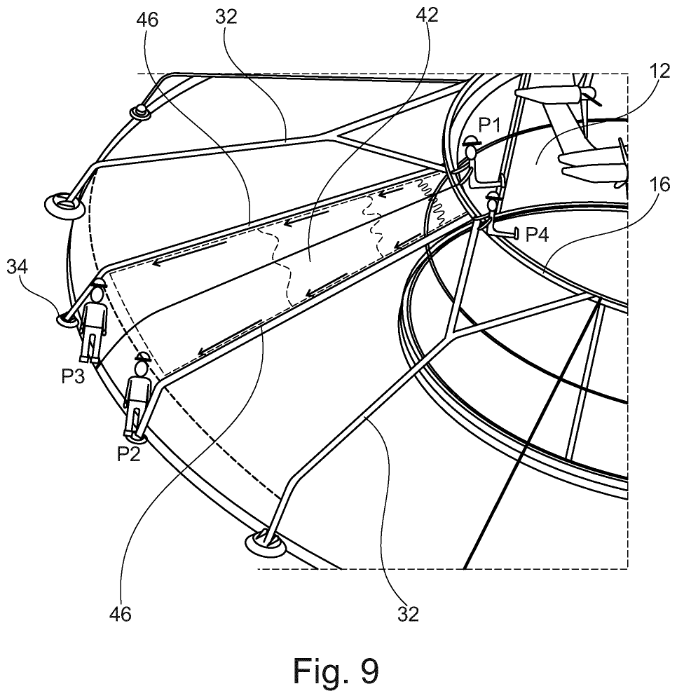

The installation of the cladding segments 42 is shown in FIG. 9. During installation, the platform 12 is raised to the upper ring 16. As mentioned herein above, each of the cladding segments 42 comprises a PVC-coated polyester material. Two personnel P1, P4 on the platform 12 feed the keeper portions 42a of opposing edges of a strip of the material, i.e. one cladding segment 42, into the upper ends of the luff tracks 50 provided on adjacent additional stabilisation beams 46. The end of the cladding segment 42 is pulled outward and downward by two further personnel P2, P3 on the ground, for example using a winch and a cable attached to the end of the strip. Thus the cladding segment 42 is drawn through the luff tracks 50 so as to extend from the upper ring 16 to the outer ends of the beams 46 at the ground, thereby spanning the gap between the two adjacent beams 46.

Each cladding segment 42 is preferably held in tension in order to prevent sagging. The tension may be provided by a weighted portion of the outer/lower end of the cladding segment 42. Sagging may also be prevented by positioning the cladding segments 42 so that they overlie the bracing members 48, such that the bracing members 48 resist downward movement of the cladding segments 42.

All of the cladding segments 42 are installed in this way (some between adjacent pairs of the additional stabilisation beams 46 (as shown in FIG. 9) and others between adjacent additional stabilisation beams 46 and Y-shaped stabilisation beams 32), so that the cladding generally covers the aerodrome structure 10 from its top to its base. Thus, the Y-shaped stabilisation beams 32 and the additional stabilisation beams 46 function as structural roof members for supporting the cladding segments 42, as well as providing enhanced lateral stability for the lift structure 14.

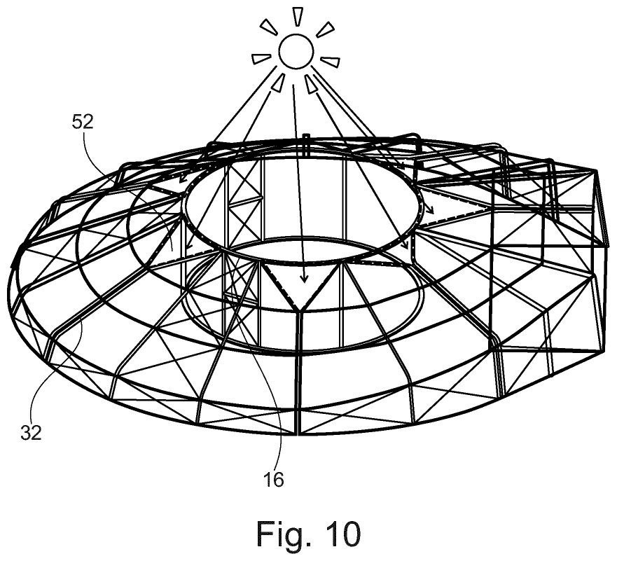

In this example, the cladding segments 42 are opaque such as to prevent sunlight from passing through the cladding segments 42 into the interior of the aerodrome structure 10. Referring to FIG. 10, transparent PVC window panels 52 are provided, in the triangular openings formed by the inner ends of the Y-shaped stabilisation beams 32 and the upper ring 16, in order to allow sunlight into the aerodrome structure 10.

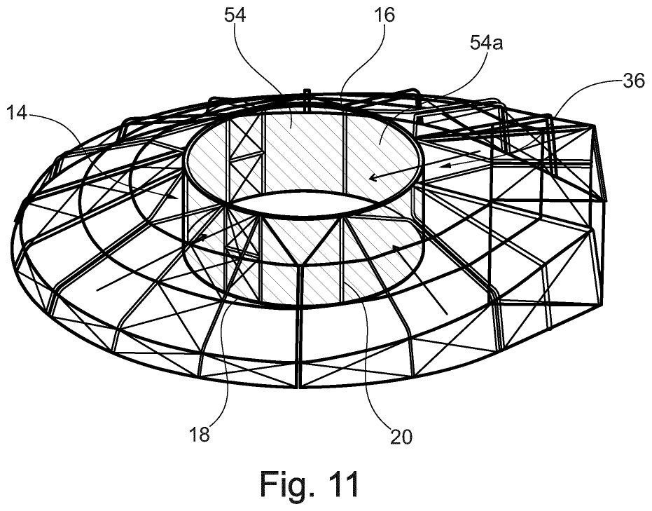

Referring to FIG. 11, transparent PVC window panels 54 are also provided around the lift structure 14, the panels 54 being attached to the lift structure columns 20 and extending between the base ring 18 and the upper ring 16. These PVC window panels 54 allow views of the platform 12 and any aircraft thereon from positions within the interior of the aerodrome structure 10. A curtain portion 54a of the panels 54 allows for access through the above-mentioned side opening 30 of the lift structure 14, for loading and unloading aircraft on and off the platform 12.

It will be understood that some of the above-described assembly steps may be performed in a different order. For example, as described herein above, the inner ends of each of the lift structure columns 20, the Y-shaped stabilisation beams 32, the additional stabilisation beams 46, and the hanger structure roof members 40 of the pre-assembled hanger structure 36, are hingedly or pivotably connected to the upper ring 16. The lift apparatus 24 is then activated in order to raise the platform 12, and thereby the upper ring 16 which rests on the platform 12, vertically upward, thereby raising the lift structure columns 20, the Y-shaped stabilisation beams 32, the additional stabilisation beams 46, and the hanger structure roof members 40 and the hanger structure columns 38, which are all then locked into position relative to the upper ring 16 in order to provide a rigid structure.

In an alternative assembly procedure, only the lift structure columns 20 are hingedly or pivotably connected to the upper ring 16, raised into position, and subsequently locked into fixed connection with the upper ring 16. The lower ends of the lift structure columns 20 are then also fixedly connected to the base ring 18, as has been described herein above. In this way, the lift structure 14 is erected to form a rigid, free-standing structure with the upper ring 16 fixed in space at the top. The platform 12 is then lowered and the inner ends of one or more of the Y-shaped stabilisation beams 32, the additional stabilisation beams 46, and the hanger structure roof members 40 of the pre-assembled hanger structure 36, are rested on the platform 12 and temporarily attached thereto, for example using chains or ropes or the like. The platform 12 is then raised to the upper ring 16 and the inner ends of the Y-shaped stabilisation beams 32, the additional stabilisation beams 46, and the hanger structure roof members 40 are released from the platform 12 and fixedly connected (locked) to the upper ring 16. It will be understood that the platform 12 may be used to move all of these structural elements from the ground to the upper ring 16 either simultaneously or sequentially.

### Feature Details

Certain features of the aerodrome structure 10 will now be discussed in greater detail.

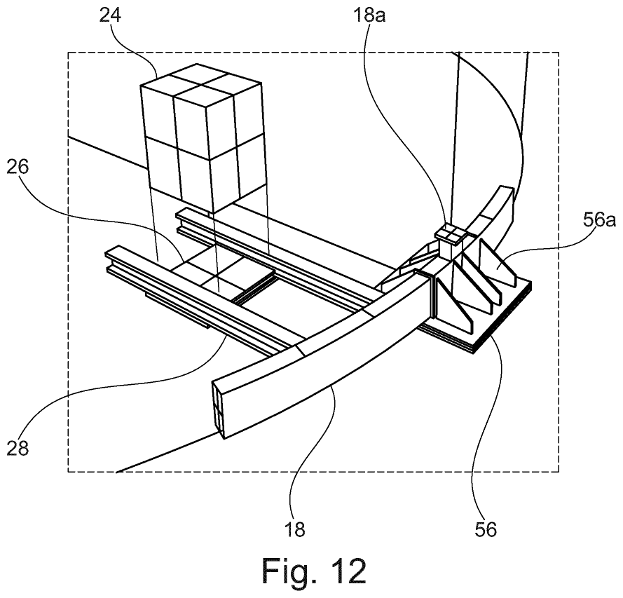

Referring to FIG. 12, the base ring 18 may be firmly supported on the ground by a plurality of base ring support plates 56 (only one of which is shown in the drawing along with a portion of the base ring 18). Each of the base ring support plates 56 comprises upstanding buttress members 56a which form a channel for receiving and supporting a portion of the base ring 18. This portion of the base ring 18 includes an upstanding projection 18a for connection with a respective one of the upstanding lift structure columns 20, as has been described herein above. The base ring support plates 56 effectively increase the area of the “footprint” of the base ring 18, thereby spreading the load (weight) of the lift structure 14 over the ground. As has been mentioned herein above, the lift apparatus 24 supports the overlying platform (not shown in FIG. 12) and is itself supported by the underlying rest plates 26 which are located on or between the base cross-beams 28. This underlying structure provides a firm supportive base for the lift apparatus 24 and the platform 12.

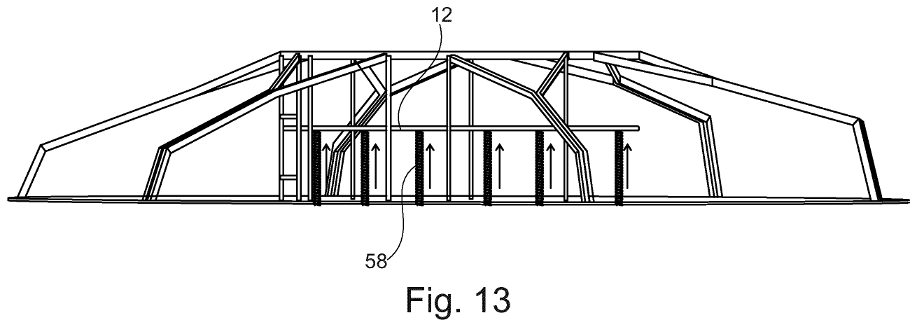

Referring also to FIG. 13, the lift apparatus 24 itself comprises at least one lift mechanism and associated ancillary equipment including a power supply. The lift mechanism may be operated electrically or hydraulically, or a combination of these. The lift mechanism is preferably compact in order to minimise the space required beneath the platform 12. Suitable lift mechanisms include scissor lifts, telescopic lifts, and chain link lifts. Preferably, a plurality of lift mechanisms are provided at strategic locations beneath the platform 12 in order to spread the lifting force over the lower surface of the platform 12. The multiple lift mechanisms may be arranged to be synchronised using gearboxes and drive shafts. This example includes a plurality of chain link lifts 58, as shown in FIG. 13. A chain link lift is a type of lift wherein a plurality of connected chain links are deployed outwardly and upwardly from a horizontal storage housing such as to form a rigid, vertical column. An example of a suitable chain link lift is that produced by Serapid (France), which is described as being an electromechanical telescopic actuator specifically designed for the vertical movement of heavy loads using rigid chain technology.

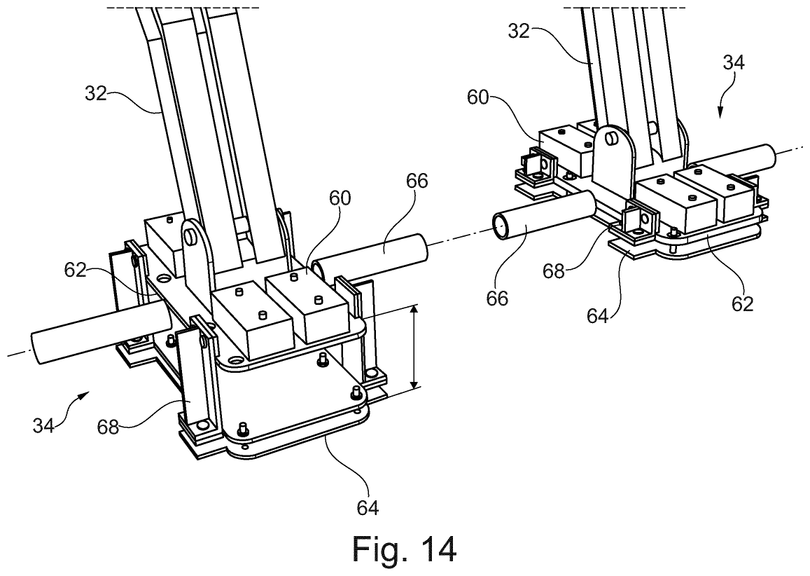

FIG. 14 shows two of the anchor members 34 which support the Y-shaped stabilisation beams 32 at the outer periphery of the aerodrome structure 10. In this example, the anchor members 34 are configured to rest on the ground, rather than be sunk into the ground, thereby avoiding a need for digging conventional foundations. Each anchor member 34 comprises ballast units, for example comprising concrete blocks or water-filled containers, in order to provide sufficient weight to resist movement relative to the ground.

The anchor members 34 are configured to be height adjustable in order to accommodate non-level ground at the site where the aerodrome structure 10 is erected. In this way the need to first level the ground may be avoided. In this example, each anchor member 34 comprises an upper plate structure 62 which connects with the Y-shaped stabilisation beam 32, and a lower plate structure 64 which lies on the ground. The upper plate structure 62 comprises laterally-extending tubular members 66, each configured to receive an end of a telescopic rod (not shown in FIG. 14) for connecting together the upper plate structures 62 of an adjacent two of the anchor members 34.

The upper and lower plate structures 62, 64 are connected to each other by upstanding struts, in this example T-shaped members 68, the height of which determines the vertical distance between the upper and lower plate structures 62, 64 and thereby the height from a ground datum of the Y-shaped stabilisation beams 32. The required heights of the T-shaped members 68 are predetermined by taking a survey of the ground at the site.

Thus, still referring to FIG. 14, the anchor member 34 on the right side rests on a part of the ground that is higher than the piece of ground which supports the anchor member 34 on the left side. Accordingly, the heights of the T-shaped members 68 are selected so that the vertical distance, between the upper and lower plate structures 62, 64 of the left side anchor member 34, is greater than the vertical distance between the upper and lower plate structures 62, 64 of the right side anchor member 34. In addition, the lower plate structure 64 of each anchor member 34 is configured to be adjustable in tilt angle, in order to accommodate sloping ground underneath the lower plate structure 64.

In this way, the lower ends of the Y-shaped stabilisation beams 32 are positioned so as to lie in the same horizontal plane and therefore to be level with each other. It will be understood that the position of each anchor member 34 can be adjusted as required prior to locking the Y-shaped stabilisation beams 32 relative to the upper ring 16, as has been described herein above. With the lower ends of the Y-shaped stabilisation beams 32 in the desired position, adjacent pairs of the laterally-extending tubular members 66 may be connected together using the insertable telescopic rods, thereby providing additional bracing to the structure of the aerodrome structure 10 at ground level.

### Container Storage

As has been mentioned herein above, the component parts of the aerodrome structure 10 are originally packaged in containers, for example standard-size shipping containers, for convenient deployment to the site where the aerodrome structure 10 is to be erected. In order to minimise the number and volume of the containers, the component parts are preferably broken down into discrete segments or elements, as has been described, this being a highly space-efficient means of packaging the aerodrome structure 10.

The contents of the containers are preferably arranged to suit the order of assembly of the aerodrome structure 10, as discussed herein above. For example, the base ring 18 and the base cross-beams 28 are preferably provided in the same container, since the base cross-beams 28 are to be connected to the base ring 18 once the base ring 18 has been set out on the ground.

In one example, the aerodrome structure 10 is packaged in a total of eight containers, or container groups each comprising a plurality of individual containers, as follows:
Container/container group 1: The base ring 18 comprising its component segments; the upper ring 16 comprising its component segments; the rest plates 26; the base cross-beams 28 comprising their component segments; and the lift mechanism.
Container/container group 2: The guide rails 22 comprising their component segments; and the lift structure columns 20 comprising their component segments and castor wheels.
Container/container group 3: The Y-shaped stabilisation beams 32 comprising their component segments and castor wheels; and the additional stabilisation beams 46 comprising their component segments and castor wheels.
Container/container group 4: The bracing members 48 comprising their component segments.
Container/container group 5: The hanger structure roof members 40 comprising their component segments; and the hanger structure columns 38 comprising their component segments and castor wheels.
Container/container group 6: The anchor members 34; and the telescopic rods.
Container/container group 7: The cladding segments 42 (preferably folded or rolled-up) and their luff tracks 50; and the transparent PVC window panels 52, 54 (preferably folded or rolled-up).
Container/container group 8: Ancillary equipment.

Preferably, the containers include hoisting equipment to ease removal of the parts of the aerodrome structure 10 from the containers. The containers also preferably include wheels, so that they can be more easily moved by personnel to the exact location on-site where the parts are required for assembly.

### Disassembly

The aerodrome structure 10 may be disassembled or dismantled and removed from site, if it is no longer required. The disassembly sequence is essentially the reverse of the assembly sequence, as follows.

The platform 12 is raised to its upper position. The cladding segments 42 are each drawn upwardly and inwardly through their supporting luff tracks 50, for example by personnel using a winch located on the platform 12. Thus the cladding segments 42 are removed from the aerodrome structure 10. The transparent PVC window panels 52 are removed from the triangular openings at the inner ends of the Y-shaped stabilisation beams 32. The transparent PVC window panels 54 are removed from the lift structure 14.

The insertable telescopic rods are removed from the laterally-extending tubular members 66 of the anchor members 34. The bracing members 48 are disconnected and removed from the adjacent pairs of the Y-shaped stabilisation beams 32 and the additional stabilisation beams 46. The lower ends of the Y-shaped stabilisation beams 32 are disconnected from the anchor members 34.

The temporary stabilisation struts 44 are re-attached to the outer surfaces of the guide rails 22. The upper ends of the guide rails 22 are disconnected from the upper ring 16. The lower ends of the lift structure columns 20 are disconnected from the base ring 18.

The inner ends of the lift structure columns 20, the Y-shaped stabilisation beams 32, the additional stabilisation beams 46, and the hanger structure roof members 40, are unlocked so as to restore their pivotable relationship with the upper ring 16. Castor wheels are attached to the lower/outer ends of the lift structure columns 20, the Y-shaped stabilisation beams 32, and the additional stabilisation beams 46.

The lower ends of the pivotably-connected lift structure columns 20 are displaced outwardly (manually by personnel, or automatically, e.g. by a spring-loaded mechanism) in order to place them into a non-vertical condition. The lift apparatus 24 is activated in order to lower the platform 12. As the upper ring 16 descends vertically with the platform 12, the lift structure columns 20 freely rotate in a plane which is perpendicular with the plane of the upper ring 16. Thus, the lift structure columns 20 are pushed downward and outward, their inclination relative to the ground progressively decreasing. The pivotably-connected additional stabilisation beams 46 and hanger structure roof members 40 are similarly pushed downward and outward.

The lift apparatus 24 is deactivated in order to halt the downward movement of the platform 12 at the region of the base ring 18. In this lowered position of the platform 12, the lift structure columns 20, the Y-shaped stabilisation beams 32, the additional stabilisation beams 46, and the hanger structure roof members 40, slope downwardly from the upper ring 16 to the ground.

The temporary cross-member (or temporary inner lip part) is re-attached to the upper ring 16 in order to support the upper ring 16 on the platform 12. The inner ends of the lift structure columns 20, the Y-shaped stabilisation beams 32, the additional stabilisation beams 46, and the hanger structure roof members 40, are disconnected and removed from the upper ring 16. The temporary cross-member (or temporary inner lip part) is removed from the upper ring 16 and the segments of the upper ring 16 are separated from each other. The upper ring 16 is thus dismantled.

The temporary stabilisation struts 44 are removed from the guide rails 22. The guide rails 22 are disconnected from the platform 12 and the elements of the guide rails 22 are separated from each other. The guide rails 22 are thus dismantled.

The segments of the platform 12 are disconnected from each other, either before or after detachment from the lift apparatus 24. The lift apparatus 24 is removed from the rest plates 26. The rest plates 26 are removed from the base cross-beams 28. The ends of the base cross-beams 28 are detached from their respective portions of the base ring 18. The segments of the base ring 18 are separated from each other. The base ring 18 is thus dismantled.

The ends of the hanger structure columns 38 are disconnected from the respective ends of the hanger structure roof members 40. The relevant elements are disconnected from each other to dismantle the lift structure columns 20, the Y-shaped stabilisation beams 32, the additional stabilisation beams 46, the hanger structure columns 38, and the hanger structure roof members 40.

The component parts of the aerodrome structure 10 are put back into their containers. The containers are loaded onto vehicles and taken away from the site. If desired, the aerodrome structure 10 may be assembled once more at a different site.

### Variants

Some variants of the aerodrome structure and its structural parts will now be described.

In the above-described example, the pre-assembled platform 12 comprises a plurality of segments or elements, for ease of packaging, transportation and handling. Once assembled and integrated into the lift structure 14, the platform 12 is a single piece. In another example, however, the assembled and integrated platform 12 comprises two or more discrete pieces or parts. That is, the platform 12 is split, segmented, or partitioned. In such an example, the lift apparatus 24 is configured to operate the different parts of the platform 12 independently of each other. Thus, a first part of the platform 12 may be activated to be raised while at the same time a second part of the platform 12 may be activated to be lowered. Or, first and second parts of the platform 12 may be activated to be raised, or lowered, at the same time but at different velocities. Also in such an example, first and second parts of the platform 12 may be activated to as to be raised or lowered together at the same velocity, such that the two parts behave as though they were a single platform 12. Splitting the platform 12 into discrete parts in this manner advantageously increases flexibility with regard to aircraft handling.

In the above-described example, guide rails 22 are connected to the base ring 18 to enhance the lateral stability of the lift structure 14 and the platform 12 thereof. The guide rails 22 are particularly effective when used in combination with the plurality of chain link lifts 58, which also form part of the above-described example, since each of the chain link lifts 58 exerts a point load on a small portion of the platform 12. However, the guide rails 22 may be omitted in examples which comprise different lift mechanisms, for example a scissor lift, where the lifting force may be applied over a larger area of the platform 12. Furthermore, the guide rails 22 may even be omitted from examples which utilise chain link lifts 58, since the size and weight of the platform 12, and/or the number and positioning of the chain link lifts 58, may be such that the chain link lifts 58 themselves provide sufficient lateral stability to the platform 12. Thus it will be understood that the guide rails 22 (and of course the temporary struts 44 that may be used in conjunction with the guide rails 22) are an optional feature of the aerodrome structure of the disclosure.

While in the above-described example some of the structural elements of the aerodrome structure 10 comprise steel, in other examples different materials may be employed. These include, but are not limited to, metals and metal alloys, for example aluminium alloy or titanium alloy, plastics materials, composite materials such as carbon fibre, and wood, or any combination of these. Preferably the structural elements are lightweight, fire resistant, and corrosion resistant.

While in the above-described example the cladding segments 42 of the aerodrome structure 10 comprise PVC-coated polyester, in other examples different materials may be employed. These include, but are not limited to, metals and metal alloys, for example aluminium, plastics materials, composite materials such as carbon fibre, and wood, or any combination of these. Preferably the cladding segments 42 are flexible, lightweight, water resistant, fire resistant, and corrosion resistant.

While in the above-described example the anchor members 34 are rested on the ground, in other examples the anchor members 34 are partially or fully buried in the ground in order to support the Y-shaped stabilisation beams 32.

While in the above-described example the upper and base rings 16, 18 of the lift structure are circular in shape, in other examples the upper and base rings are non-circular, for example oval, elliptical, or rectangular, for example square.

While in the above-described example the cladding comprises a fabric material, in particular PVC-coated polyester, other examples may include different kinds of cladding. In one example, mounting tracks are attached to the upper surfaces or the undersides of the Y-shaped stabilisation beams 32 and/or the additional stabilisation beams 46. Click-on panels or screens are then pressed into the tracks so as to cover the aerodrome structure 10. The click-on methodology is less labour intensive and more time-efficient than other means of attachment such as screw fixings. It also requires no specialist skills or tools.

While in the above-described example the stabilisation beams 32 are Y-shaped, in other examples the beams have other shapes. For example, the stabilisation beams may be elongate and generally straight in plan view. Also, while in the above-described example the aerodrome structure 10 includes additional stabilisation beams 46, in other examples these are omitted. It will be understood that the aerodrome structure 10 may comprise any number and form of stabilisation beams, provided that the beams extend from the lift structure (preferably the upper ring thereof) to the ground, both in order to enhance lateral stability of the lift structure and also to provide a structure for supporting the external cladding which defines the interior volume of the aerodrome structure 10. The stabilisation beams may be of any suitable shape in cross-section, for example the classic I-beam cross-section as shown in FIG. 8.

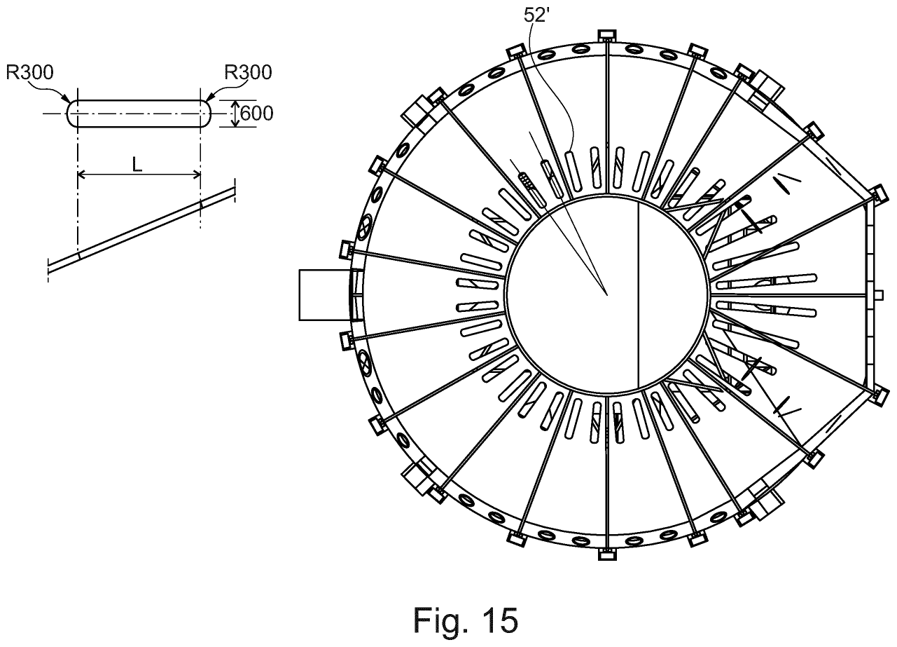

It will be understood that, in examples which comprise stabilisation beams having shapes other than Y-shapes, the transparent PVC window panels will take a different shape than that shown in FIG. 10, due to an absence of the triangular apertures formed by the Y-shaped beams in the above-described example. In such examples, the transparent PVC window panels may take any other suitable shape. One example is shown in FIG. 15, wherein the transparent PVC window panels 52′ are generally elongate ovals which extend radially from the upper ring 16.

While the above-described example comprises cladding segments 42 which are opaque, such as to prevent sunlight from passing through the cladding segments 42 into the interior of the aerodrome structure 10, in other example the cladding segments 42 may be transparent or translucent, so as to allow sunlight to pass through the cladding segments 42 into the interior of the aerodrome structure 10. In such examples the cladding segments 42 may comprise one or more of the materials mentioned herein above. In some such examples, the transparent or translucent cladding segments 42 are used in conjunction with windows of the aerodrome structure 10, as have been described herein above. In other such examples, the windows are omitted.

While the above-described example comprises a hanger structure 36 including an entrance/exit for aircraft, in other examples the hanger structure 36 is omitted. In some such examples, one or more of the cladding segments 42 is configured to permit aircraft to enter and leave the interior of the aerodrome structure 10. For example, referring to FIG. 1, a cladding segment 42a may be configured to be rotated about a hinge point at the upper ring 16, using powered hydraulic struts or the like, in order to lift the cladding segment 42a upward so as to form an opening in the side of the aerodrome structure 10.

It will be understood that the aerodrome structure has been described in relation to its preferred embodiments and may be modified in many different ways without departing from the scope defined by the accompanying claims.

### Detailed Description of a Terrain Adjustable Foot

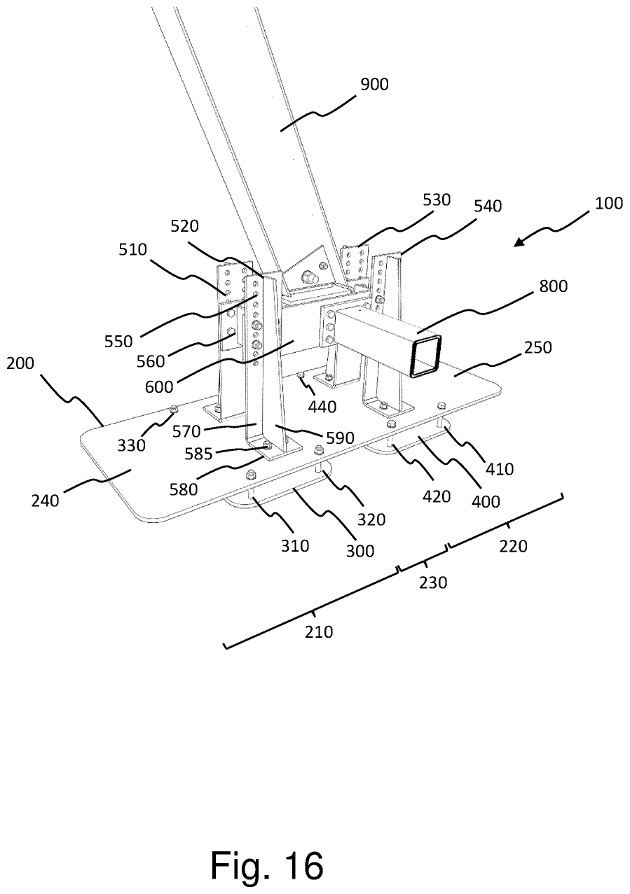

FIG. 16 shows a foot 100 for supporting a piece of infrastructure, such as an aerodrome structure 10 in accordance with the disclosure. The foot may be used in place of the anchor 34 described above. The foot 100 may be applicable to any piece of infrastructure and is not limited to use in an aerodrome structure 10.

The foot 100 comprises a platform 200 having a first portion 210, a second portion 220 and a central portion 230 between the first portion 210 and the second portion 220. The first portion 210 comprises a first surface 240 and the second portion 220 comprises a second surface 250.

The foot 100 also comprises a first base 300 configured to support the first portion 210 and a second base 400 configured to support the second portion 220 of the platform.

The foot 100 comprises at least a first four rods 310, 320, 330, 340 that each extend between the first base 300 and the first portion 210. The first four rods 310, 320, 330, 340 each comprise a threaded rod configured for use with a corresponding nut in order to facilitate independent adjustment of each of the first four rods 310, 320, 330, 340. Independent adjustment means that it is possible that the length of a portion of each of the first rods that extends between the first base 300 and the first portion 210 may be different from that equivalent length for each of the other rods. In this way, the first base 300 may be non-parallel with the platform 200. Therefore, it is possible for the first base 300 to be resting on an incline but for the first portion 210 to be adjusted so as to be horizontal.

Similarly, the foot 100 comprises at least a second four rods 410, 420, 430, 440 that each extend between the second base 400 and the second portion 220. The second four rods 410, 420, 430, 440 each comprise a threaded rod for use with a corresponding nut in order to facilitate independent adjustment of each of the second four rods 410, 420, 430, 440. Independent adjustment means that it is possible that the length of a portion of each of the second rods that extends between the second base 400 and the first portion 220 may be different from that equivalent length for each of the other second rods. In this way, the second base 400 may be non-parallel with the platform 200 and non-parallel with the first base 300. Therefore, it is possible for the first base 300 to be resting on an incline but for the second portion 220 to be adjusted so as to be horizontal.

By adjusting the first base 300 and the second base 400 appropriately, using, respectively, the first four rods 310, 320, 330, 340 and the second four rods 410, 420, 430, 440, it is possible to adjust the platform 200 so as to be horizontal even when the first base 300 and the second base 400 are resting on inclines.

The foot 100 also comprises a first pair of legs 510, 520 projecting upwards from the first portion 210 of the platform 200 and a second pair of legs 530, 540 projecting upwards from the second portion 220 of the platform 200.

Each leg of the first and second pairs of legs 510, 520, 530, 540 may comprise a stem 570, a base 580, and a brace 590, extending between the stem 570 and the base 580. Each base 580 is parallel to the platform 200. In the illustrated embodiment, the base 580 of each leg is fastened to the platform using fixings 585.

The foot 100 further comprises a beam 600 having a first end and a second end. The first end is supported by the first pair of legs 510, 520 and the second end is supported by the second pair of legs 530, 540.

The first pair of legs 510,520 comprises a first range of attachment positions 550 for supporting the beam 600 at a first variety of vertical positions. The second pair of legs 530, 540 comprises a second range of attachment positions 550 for supporting the beam 600 at a second variety of vertical positions that correspond with the first variety of vertical positions. In this way, a height of the beam 600 is selectable by selecting one of the first variety of vertical positions and a corresponding one of the second variety of vertical positions in such a way that the beam 600 is parallel to the platform 200.

In the illustrated configuration the first range of attachment positions 550 and the second range of attachment positions 550 comprises a series of equally spaced apertures. The beam 600 comprises pairs of apertures that correspond with a pair of apertures of the attachment positions 550 of the legs 510, 520, 530, 540. In this way, the beam 600 may be positioned and fastened to a pair of apertures of the equally spaced apertures in accordance with a required height. To the extent that further, more precise, vertical adjustment is required, the first four rods 310, 320, 330, 340 and the second four rods 410, 420, 430, 440 may be adjusted in parallel so as to maintain horizontality of the platform 200 whilst enabling modest vertical adjustment of the platform 200.

The apertures of the attachment positions 550 and the apertures in the beam 600 may be connected by means of bolts or threaded bar with corresponding nuts.

The foot may be of steel, of composite material, or of any other suitable material. An underside of the first base 300 and an underside of the second base 400 may be of a material having a coefficient of friction that exceeds a friction threshold in order to avoid lateral movement of the feet 100. The material of the underside of the first base 300 and the underside of the second base 400 may further accommodate minor deformations so as to compensate for minor undulations in the surface on which the first base 300 and the second base 400 is supported.

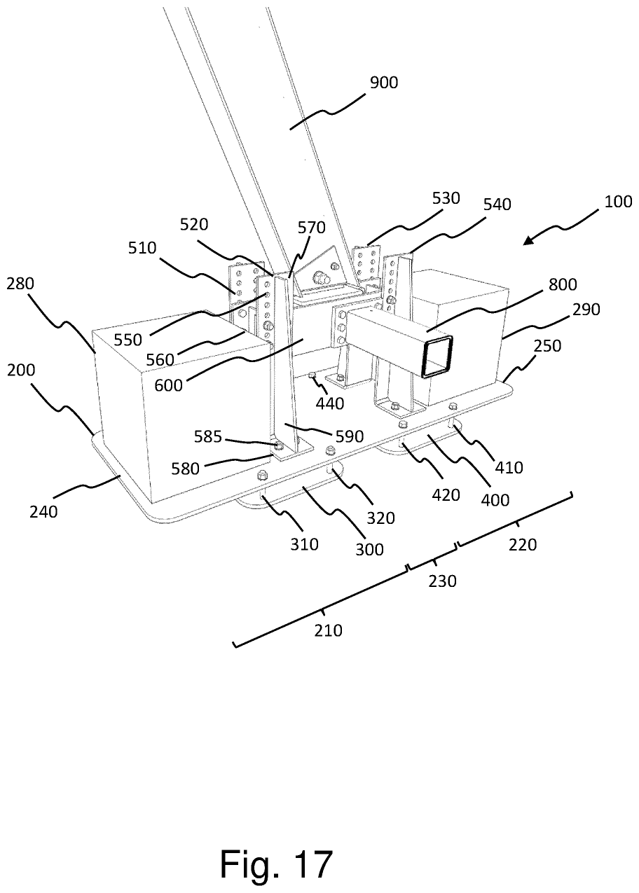

FIG. 17 shows the foot 100 of FIG. 16 deployed with first and second ballast elements 280, 290. The first ballast element 280 is supported by the first surface 240 and the second ballast element 290 is supported by the second surface 250. In this way, both the first pair of legs 510, 520 and the second pair of legs 530, 540 are disposed between the first and second ballast elements 280, 290.

The first surface 240 may cantilever from the first base 300 in a direction away from the central portion 230. The second surface 250 may cantilever from the second base 400 in a direction away from the central portion 230.

The ballast elements 280, 290 may be of concrete, of steel, or of any other material of sufficient density to reduce the risk of movement of the foot 100.

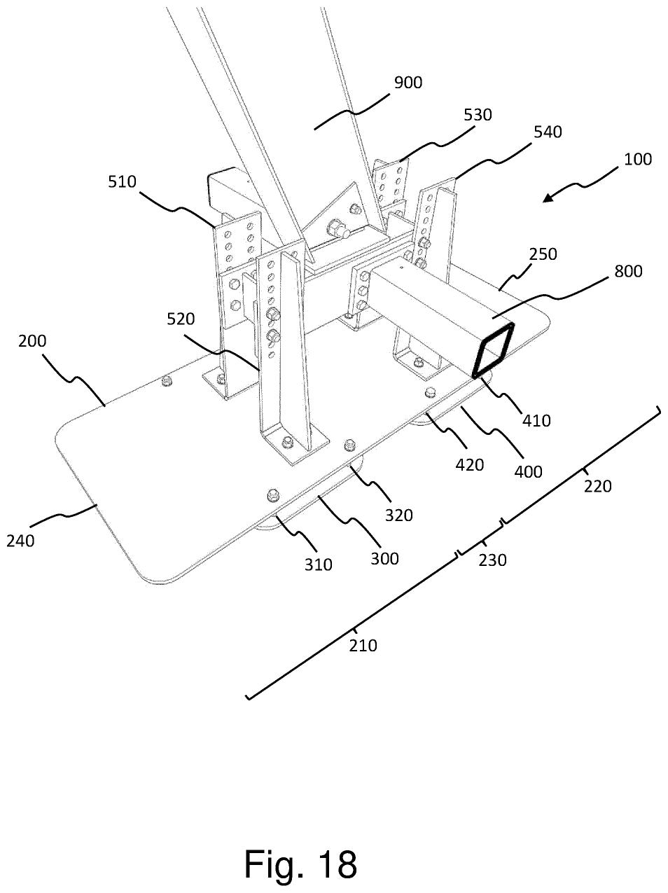

FIG. 18 shows the foot of FIG. 16 from a different perspective.

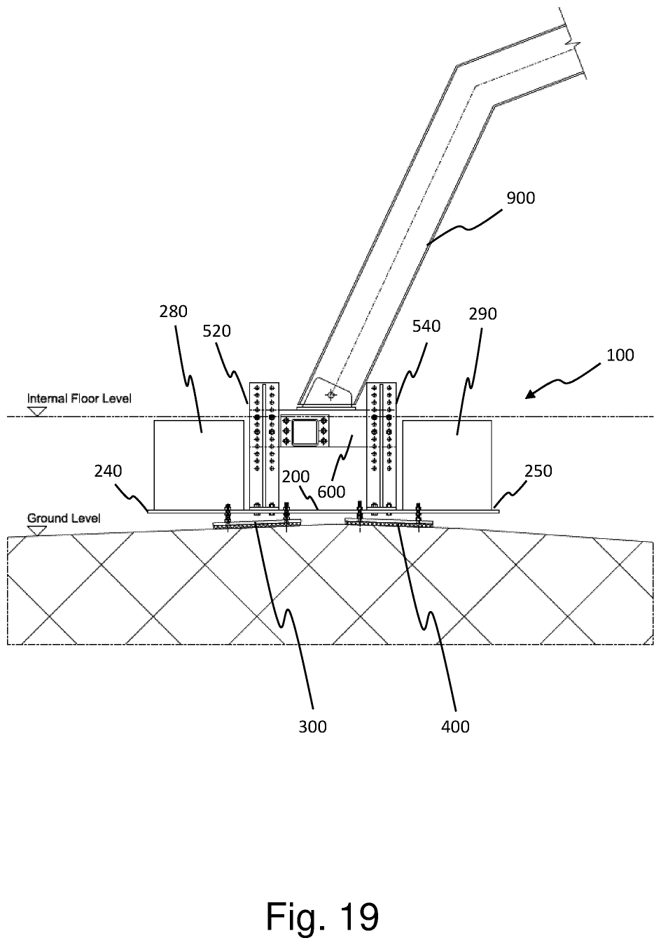

FIG. 19 shows a side view of the foot of FIG. 16 in situ on uneven ground. It can be seen that the first base 300 is on a first incline and the second base 400 is on a second incline different from the first incline. In this way, neither the first base 300 nor the second base 400 is horizontal yet the platform 200 is horizontal.

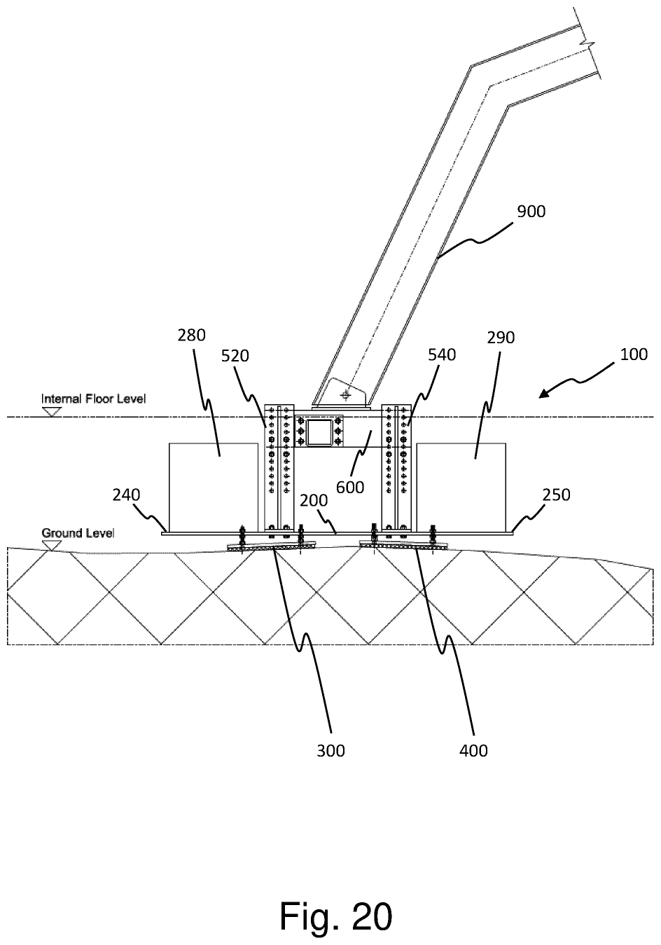

FIG. 20 shows exactly the same components as FIG. 19, but the first base 300 is on a third incline and the second base 400 is on a fourth incline different from the third incline. In this way, neither the first base 300 nor the second base 400 is horizontal yet the platform 200 is horizontal. Furthermore, it can be seen that the while the ground level shown in the FIG. 19 embodiment is higher than the ground level shown in the FIG. 20 embodiment, in each case the platform 200 is at a height consistent with the platform 200 of the other foot in the other Figure. This means that when the feet shown in FIGS. 19 and 20 are deployed in a single building, the floor level (consistent with the height of the beam 600) is horizontal between one foot and the other.

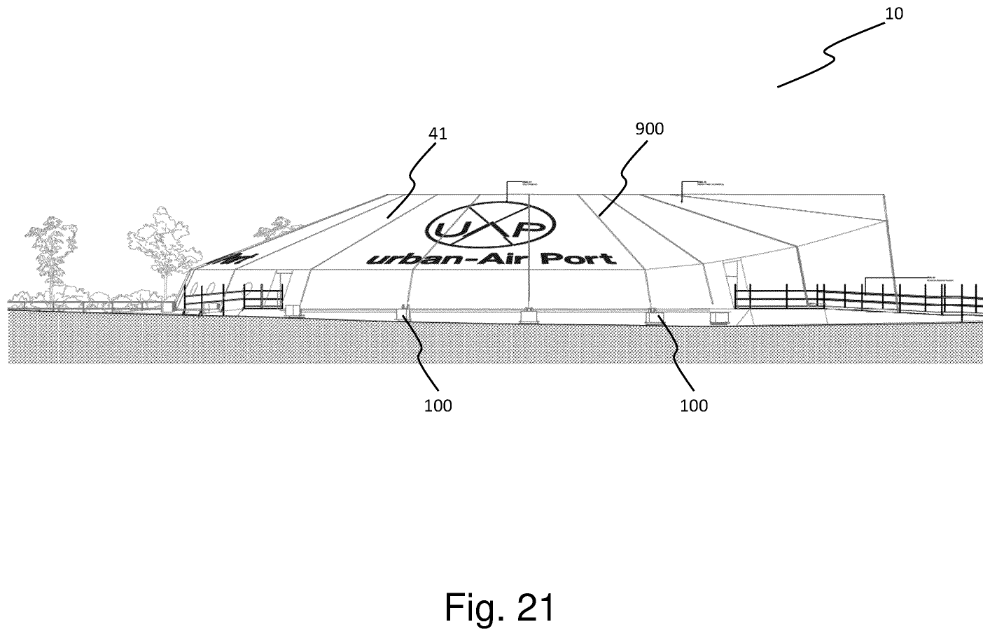

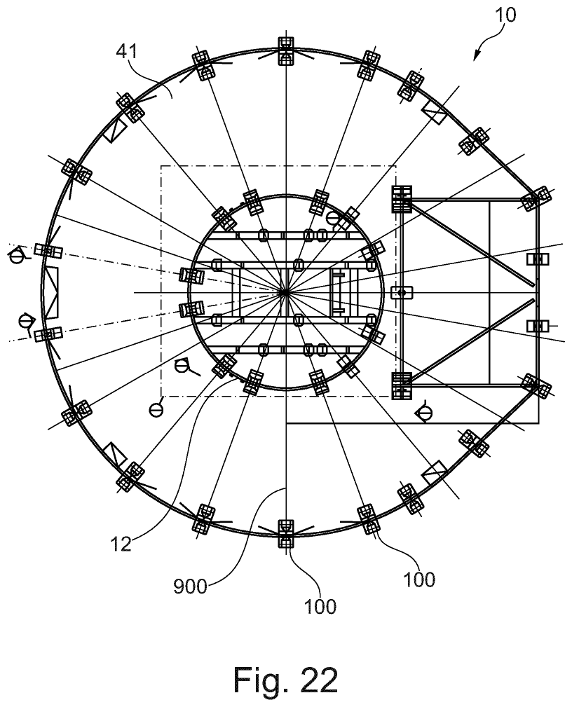

FIGS. 21 and 22 show a building 10, in a side view and in a plan view, respectively, that deploys the feet 100 of the present disclosure. The building 10 in question is an airport for vertical take of and landing vehicles, also known as a vertiport. The vertiport 10 comprises a FATO 12 (Final Approach and Takeoff area) having a circular perimeter that is surrounded by an annular enclosed space bounded by an outer ring defined by the feet 100 of the present disclosure and an inner ring at a perimeter of the FATO 12. The annular space may be covered with a roof structure 41.

Thus, the feet 100 of the present disclosure may be used to support a structure on uneven ground, not only across the area of the building, but also across the area of each individual foot. This, in turn, makes possible a horizontal floor of the structure notwithstanding it being deployed on an uneven ground. On the basis of such a horizontal structure, a horizontal platform for vertical take off and landing aircraft may be provided. Moreover, no penetration of the ground is required. In addition, the nature of the feet and the structure is such that assembly may be rapid and disassembly may be easily feasible and rapid, with straightforward return of the ground to its original state prior to deployment of the building.

1.-21. (canceled)

22. A lift structure for an aerodrome structure, comprising:
an upstanding tubular frame comprising an upper ring located over a base ring and supported thereon by columns;
a platform located within the tubular frame; and
a lift mechanism arranged to raise and lower the platform between the base ring and the upper ring,
wherein:
the columns are spaced apart from each other to provide a side opening for loading an aircraft onto the platform and unloading an aircraft therefrom when the platform is in a lowered position; and
the platform provides a take-off and landing pad for an aircraft when the platform is in a raised position.

23. A lift structure according to claim 22, comprising base support cross-members located within the base ring and connected thereto, the lift mechanism being located beneath the platform and supported by the base support cross-members.

24. A lift structure according to claim 22, wherein:
the platform comprises discrete first and second platform parts; and
the lift mechanism is arranged to raise and lower the first and second platform parts independently of each other in one mode of operation.

25. A lift structure according to claim 24, wherein the lift mechanism is arranged to raise and lower the first and second platform parts together in another mode of operation.

26. A lift structure according to claim 22, wherein the lift mechanism comprises at least one chain link lift located beneath the platform.

27. A lift structure according to claim 22, comprising guide rails extending between the base ring and the upper ring, the platform being movably connected to the guide rails, the lift mechanism being arranged to raise and lower the platform along the guide rails between the base ring and the upper ring.

28. An aerodrome structure, comprising:
a lift structure according to claim 22;
a plurality of anchor members located on the ground around the lift structure;
a plurality of radially-extending stabilization members each comprising a first end connected to the upper ring and a second end connected to a respective one of the anchor members; and
a plurality of cladding segments supported by the stabilization members, each cladding segment spanning a gap between an adjacent pair of the stabilization members and extending between the upper ring and the second ends of said adjacent pair of the stabilization members, thereby to define a covered interior volume of the aerodrome structure.

29. An aerodrome structure according to claim 28, wherein each of the cladding segments comprises a fabric material, wherein optionally the fabric material comprises PVC-coated polyester.

30. An aerodrome structure according to claim 28, wherein one or more of: the base ring; the platform; the guide rails; the upper ring; the columns; and the stabilization members, comprises aluminum alloy or steel.

31. An aerodrome structure according to claim 28, comprising a hanger structure for accommodating at least one aircraft and located adjacent to the side opening, for loading an aircraft onto the platform and unloading an aircraft from the platform when the platform is in the lowered position.

32. An aerodrome structure according to claim 31, wherein the hanger structure comprises hanger structure roof members connected to the upper ring and upstanding hanger structure columns connected to the hanger structure roof members and to respective ones of the anchor members.

33. An aerodrome structure according to claim 28, wherein the anchor members are configured to be height adjustable in order to position the second ends of the stabilization members at the same height as each other from a ground datum.

34. A method of constructing the aerodrome structure of claim 28, the method comprising:
providing the base ring on the ground;
providing the lift mechanism within the base ring;
attaching the platform to the lift mechanism such that the platform is located above the lift mechanism;
providing the upper ring on the platform;
pivotably connecting first ends of the columns to the upper ring such that the columns are in spaced relationship with each other around the upper ring and extend radially from the upper ring toward the ground;
pivotably connecting the first ends of the stabilization members to the upper ring such that the stabilization members are in spaced relationship with each other around the upper ring and extend radially from the upper ring toward the ground;
activating the lift mechanism in order to raise the platform and thus the upper ring located thereon, thereby to draw the pivotably connected columns into a substantially vertical condition and the pivotably connected stabilization members into an inclined condition with respect to the ground;
locking the first ends of the columns and the first ends of the stabilization members into fixed relationship with the upper ring;
connecting second ends of the columns to the base ring so as to be in fixed relationship therewith;
providing the anchor members on the ground and connecting the second ends of the stabilization members to the respective anchor members so as to be in fixed relationship therewith; and
attaching the cladding segments to the stabilization members.

35. A method of constructing an aerodrome structure according to claim 34, the method comprising adjusting the height of one or more of the anchor members in order to position the second ends of the stabilization members at the same height as each other from a ground datum.

36. A method of constructing an aerodrome structure according to claim 34, the method comprising:
before activating the lift mechanism in order to raise the platform, connecting first ends of guide rails to the base ring such that the guide rails extend upwardly from the base ring and are in spaced relationship with each other around the base ring and the platform; and
connecting the guide rails to the platform such as to allow height adjustment of the platform relative to the guide rails.

37. A method of constructing an aerodrome structure according to claim 36, the method comprising:
after activating the lift mechanism in order to raise the platform, connecting second ends of the guide rails to the upper ring so as to be in fixed relationship therewith.

38. A method of constructing an aerodrome structure according to claim 34, the method comprising assembling one or more of: the base ring; the platform; the guide rails; the upper ring; the columns; and the stabilization members, from a plurality of discrete component parts.

39. A kit of parts for the lift structure of claim 22, comprising:
a set of ring segments configured to be connected together to form the base ring;
a set of ring segments configured to be connected together to form the upper ring;
a plurality of sets of column segments, the segments of each set of column segments being configured to be connected together to form one of the columns, one of the segments in each set of column segments being configured to be connected to the base ring and another of the segments in each set of column segments being configured to be connected to the upper ring;
a set of platform segments configured to be connected together to form the platform; and
a lift mechanism configured to be connected to the platform.

40. A kit of parts according to claim 39, wherein the lift structure comprises guide rails extending between the base ring and the upper ring, the platform being movably connected to the guide rails, the lift mechanism being arranged to raise and lower the platform along the guide rails between the base ring and the upper ring, the kit of parts comprising a plurality of sets of guide rail segments, the segments of each set of guide rail segments being configured to be connected together to form one of the guide rails, one of the segments in each set of guide rail segments being configured to be connected to the base ring, each of the guide rails being configured to be connected to the platform.

41. A kit of parts according to claim 39, the kit of parts comprising:
a plurality of the anchor members;
a plurality of sets of stabilization member segments, the segments of each set of stabilization member segments being configured to be connected together to form one of the stabilization members, at least one of the segments in each set of stabilization member segments being configured to be connected to the upper ring and another of the segments in each set of stabilization member segments being configured to be connected to a respective one of the anchor members; and
a plurality of the cladding segments.
